(19) United States
(12) Patent Application Publication
(10) Pub. No.: US 2011/0145036 A1
(43) Pub. Date: Jun. 16, 2011

(54) CHANGE MANAGEMENT IN ROUTE-BASED PROJECTS

(76) Inventors: Richard Beary Herschmann, JR., (US); Dong Phuong Vo, Houston, TX (US); Rodger Paul Bird, Nausau Bay, TX (US)

(21) Appl. No.: 12/636,862

(22) Filed: Dec. 14, 2009

(51) Int. Cl. G06Q 10/00

(52) U.S. Cl. 705/7.23; 705/7.26; 705/7.41

(57) ABSTRACT

Managing change in the design of a route-based project. Receiving data (a ticket) regarding a proposed change to the design of a route-based project. Associating the ticket with a project in a geographic information system (GIS). Communicating the ticket to an Analyst. Receiving spatializing data regarding the ticket. The ticket and spatializing data comprising a spatialized ticket. Communicating the spatialized ticket to a Quality Control Administrator. Receiving quality control approval of the spatialized ticket. Communicating the quality control approved ticket to at least one reviewer. Receiving recommendation from reviewers. The recommendations and the quality control approved ticket comprising a reviewed ticket. Communicating the reviewed ticket to at least one approver. Receiving approval from the approver. The approval and the reviewed ticket comprising an approved ticket. Committing the change described in the approved ticket to the GIS.

### BACKGROUND

Planners, engineers, surveyors, project managers, and other project stakeholders in route-based projects, e.g., pipeline projects, environmental survey areas, roads, buried cable, right of way areas, are concerned with processing and implementing changes to project design. While geographic information systems (GIS) exist for capturing and managing the configuration of design on such projects, such systems do not provide sufficient functionality for managing the change process.

### DESCRIPTION OF THE DRAWINGS

FIG. 1 illustrates a Management of Change (MOC) access page.

FIG. 2 illustrates a MOC ticket summary page.

FIG. 3 illustrates a Variation Form of the technology.

FIG. 4 illustrates an ArcGIS page as modified by a drawing template and toolbar of the technology

FIG. 5 illustrates a MOC ticket processing form.

FIG. 6 illustrates a MOC ticket summary page with Quality Control (QC) summary table.

FIG. 7 and FIG. 8 illustrate a MOC ticket review page.

FIG. 9 is a flow chart illustrating methods of use of the technology.

### DETAILED DESCRIPTION OF THE TECHNOLOGY

Reference will now be made in detail to embodiments of the technology. Each example is provided by way of explanation of the technology only, not as a limitation of the technology. It will be apparent to those skilled in the art that various modifications and variations can be made in the present technology without departing from the scope or spirit of the technology. For instance, features described as part of one embodiment can be used on another embodiment to yield a still further embodiment. Thus, it is intended that the present technology cover such modifications and variations that come within the scope of the technology.

Participants and stakeholders in the design of route-based projects typically modify the design repeatedly in response to facts on the ground that effect cost, schedule, and performance. At any point, a participant or stakeholder such as an engineer, surveyor, right-of-way planner, or client can determine the need to consider a change to the current design. The Management of Change (MOC) technology supports capturing, reviewing such design changes, and saving approved changes to the design.

The MOC technology works in conjunction with a GIS system such as ArcGIS from ESRI to manage change of both spatial and non-spatial datasets for route-based projects. ArcGIS is an integrated collection of GIS software products that provides a standards-based platform for spatial analysis, data management, and mapping. The MOC technology modifies ArcGIS in at least two ways.

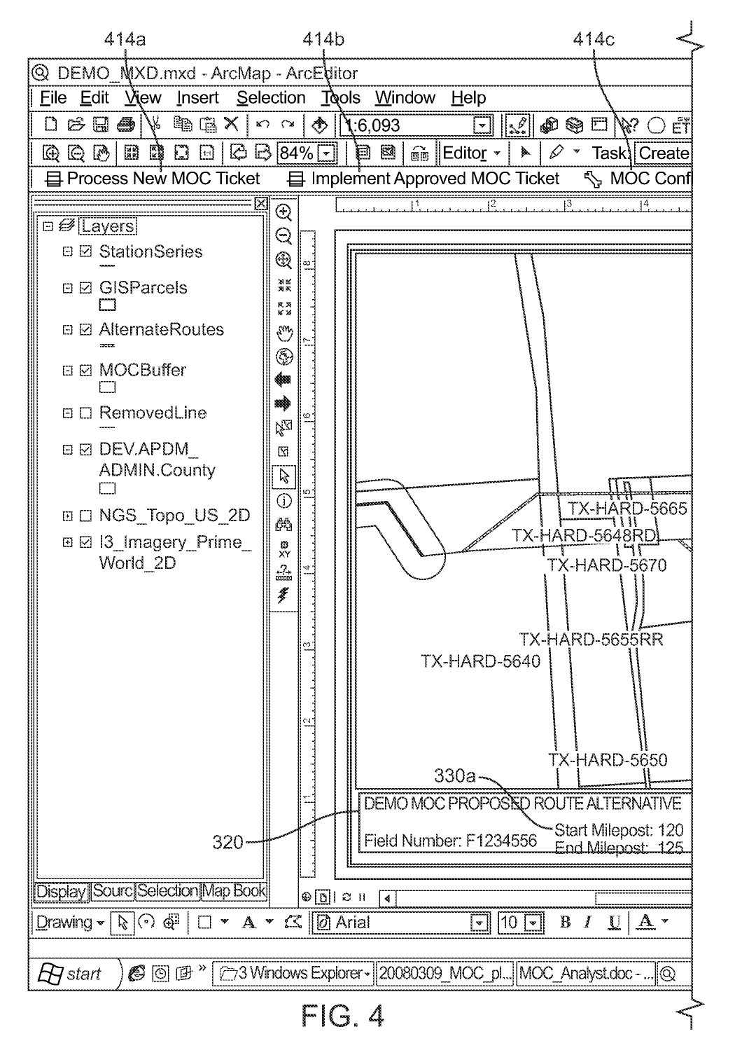

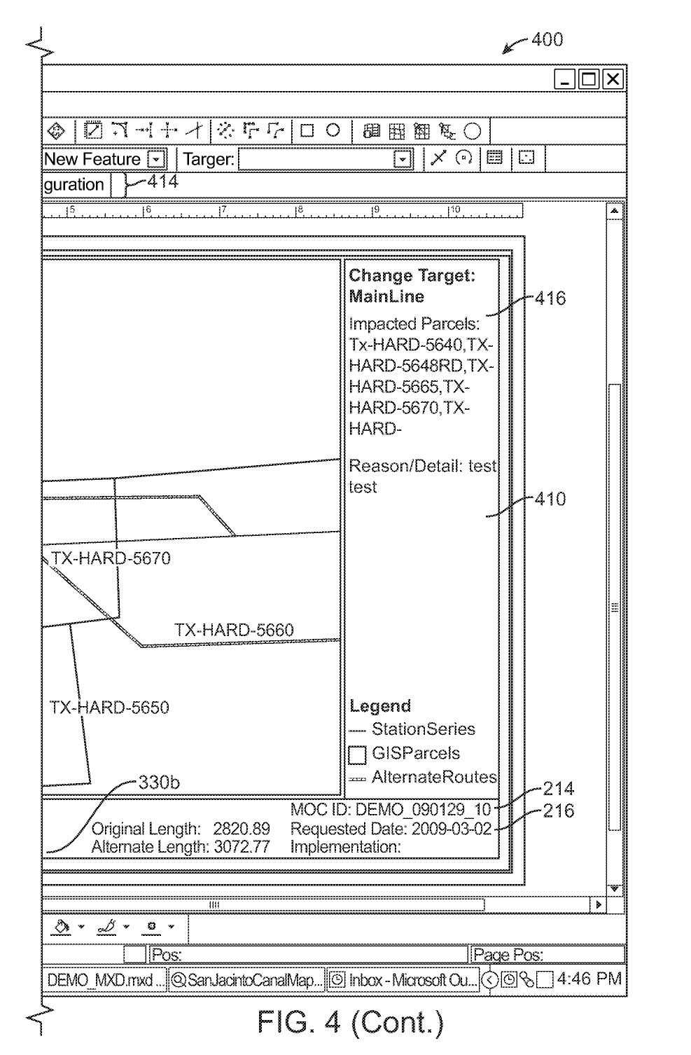

First, referring to FIG. 4, a user may modify the default ArcGIS document template to conform to project standards. FIG. 4 illustrates a window 400 from the ArcGIS ArcMAP application showing a document template 410 configured to operate with the MOC technology. The template footer, illustrates use of MOC ticket fields (explained elsewhere herein) including MOC ID 214, Requested Date 226 (e.g., date created), Start Milepost 330a, End Milepost 330b, Impacted Parcels 416 (populated by a spatial query to the GIS database), and Field Number 320.

Second, a MOC toolbar 414 is installed in ArcGIS using known methods for installation of third-party toolbars in software applications. The MOC toolbar 414 illustrated in FIG. 4 provides three (3) choices: Process New MOC Ticket 414a (also used to process a MOC ticket revised to eliminate input errors), Implement Approved MOC Ticket 414b, and MOC Configuration 414c (used to set up connections to the database(s) for a project). Each button on the toolbar invokes a set of MOC functionality described in detail elsewhere herein. Activating Process New MOC Ticket 414a invokes a windows form to present further pages of the technology. The MOC toolbar is dockable at various locations in the window in a manner known in the art.

In some embodiments, a change request is captured via a series of browser pages served by the MOC server, including one or more browser-enabled forms, e.g., webforms, accessible via the World Wide Web using uniform resource locators (URLs) in a conventional web browser.

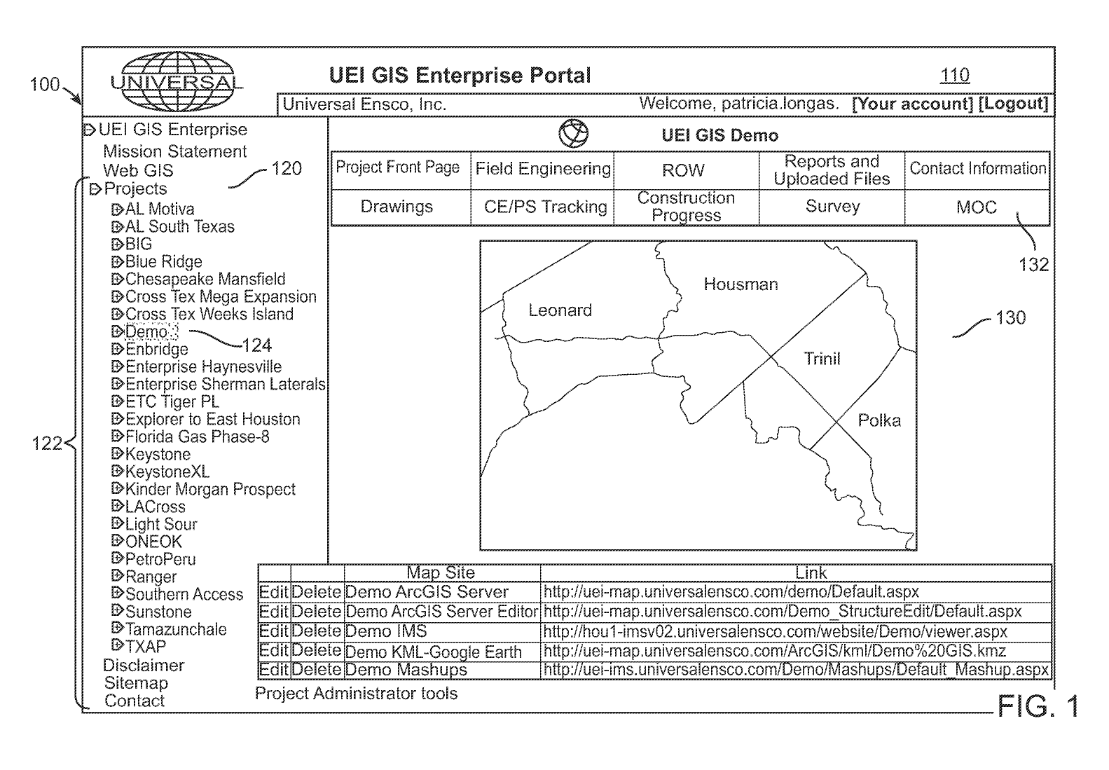

FIG. 1 illustrates an example web page 100 used to access the technology. The page includes a banner 110 for an enterprise-wide graphic information system (GIS) of which the illustrated embodiment of the technology is a part. The left side of the page 100 displays a dynamic (e.g., expanding and collapsing) navigation tree 120 for the web presence of the GIS. A projects branch 122 of the tree 120 serves as a header for branches for each project, e.g., Demo 124, using the technology. An access pane 130 is presented to the right of the navigation tree and below the banner 110. Activation of a link 132 navigates the browser to further pages of the technology. In these embodiments, a user is already logged on an enterprise geographic information system (GIS) with a valid username and password. The user would activate the MOC radio button 132 to access further functionality of the technology.

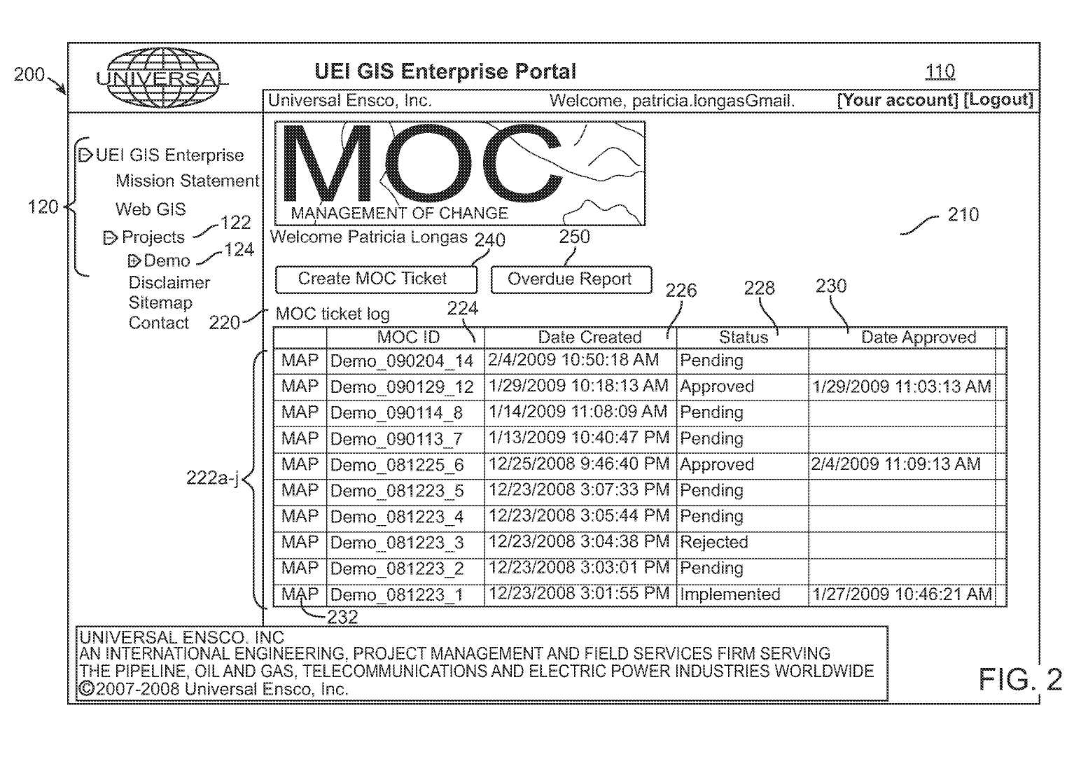

FIG. 2 illustrates an example MOC ticket summary page 200. The page 200 can be accessed via the MOC radio button 132 of the access page 100. The summary page 200 can include banner 110 and navigation tree 120, along with a summary pane 210. The summary pane 210 presents a MOC ticket log 220 comprising records for a plurality of MOC tickets 222a-222j. Each record 222 in the log 220 is characterized by a set of fields, including a unique identifier (MOC ID) 224, creation date (Date Created) 226, Status 228, Date Approved 230, and a selectable icon (MAP) 232. The MOC ID 224 can be formatted to indicate a descriptor, e.g., “Demo” is a project descriptor, concatenated with “_<YYMMDD>_<sequence number on that day>”, e.g., “Demo_{—}090204_{—}14” for the fourteenth request entered on Feb. 2, 2009 in the Demo project. Valid data for the Status 228 field includes: “Data Input,” “Pending,” “Approved,” “Rejected,” and “Implemented.” The MAP icon 232 provides a link to a representation of the subject of the MOC ticket on a map, e.g., such as show as 410 in FIG. 4. The left side of the page 200 presents the navigation tree 120, showing branches such as the projects branch 122 in the same fashion as illustrated in FIG. 1. However, in this illustration, only the Demo project 124 is indicated. The page 200 presents radio buttons 240, 250 that allow a user to take actions such as Create MOC Ticket and obtain an Overdue Report (e.g., a report showing the pendency of MOC tickets pending at or beyond a threshold. Other embodiments of the technology offer radio buttons for actions such as quality assurance and administration.

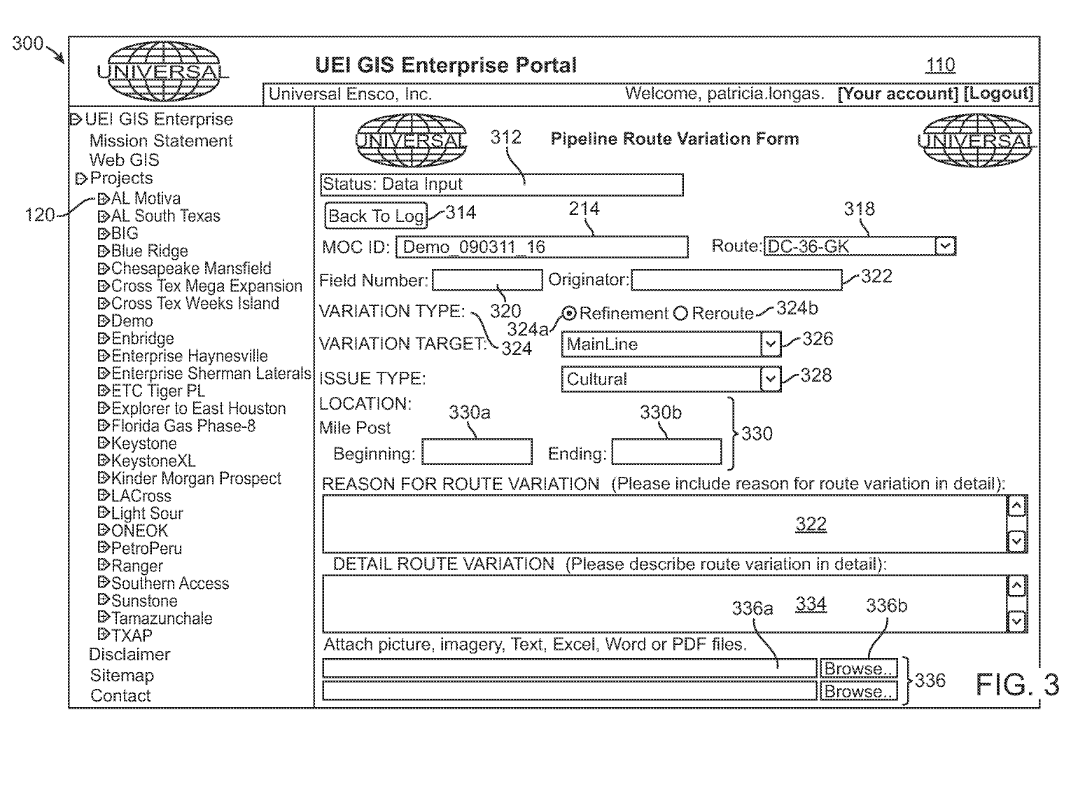

Upon selection of the Create MOC Ticket radio button 240, the technology presents the window 300 illustrated by FIG. 3. Under the portal banner 110, and to the right of the navigation tree 120, a Pipeline Route Variation Form 310 is presented. While exemplified with a pipeline example, the present technology is operable with other project types that involve routes, e.g., utility lines, roadways.

Starting from the top of the form under the form sub-banner and proceeding generally down the form, an indication of the MOC ticket Status 312 is displayed; in the illustrated case, a new MOC ticket, the status is “Data Input.” A Back To Log radio button 314 provides a link to the MOC ticket summary page 200. In some embodiments, selecting Back To Log 314 will result in creation of a new ticket bearing the MOC ID displayed in a subsequent field; while in other embodiments selecting Back To Log 314 will result in abandoning the data entered into the form 310 without creating a new MOC ticket. For new MOC tickets, the technology generates a MOC ID to associate the proposed change with a project, and to uniquely identify the change within the project. Given a project, the technology—having access to project data—populates the drop-down list Route 318 with the routes applicable to the project associated with the MOC ID. The Field Number field 320 can be an alias for a section of an overall project. The Originator text box 322 calls for the name of the person initiating the MOC ticket.

In some embodiments, there are two possible variation types in a change proposal. The technology calls for choice of Variation Type 324 as either a refinement or a reroute through selection of one of the Refinement checkbox 324a or the Reroute checkbox 324b. A refinement generally involves items in close proximity and within the site boundary/survey corridor. A reroute requires a number of changes including some outside the site boundary/survey corridor. The Variation Target field 326 provides a drop-down list of target types, e.g., specific linear elements, specific non-linear elements, in the project. The user selects the target type that is affected by the proposed change. Variation target types for pipeline projects include main line, lateral, valve site, right-of-way, and compressor site. The Issue Type field 328 presents a pull-down list of issues types prompting the proposed change. Issue types for pipeline projects include cultural, right-of-way, engineering, environmental, and other. LOCATION fields 330 indicate the approximate milepost along the route where the proposed change is located by use of Beginning 330a and Ending 330b milepost fields. Two free text windows, REASON FOR ROUTE VARIATION 332 and DETAIL ROUTE VARIATION 334 follow and allow a user to describe the reason for the proposed change and the proposed change itself.

In order to facilitate understanding of a proposed change, MOC tickets can include attached files such scanned items (e.g., sketches in pdf format), spreadsheet files, screen shots, photos, and documents. The Variation Form 310 provides at least one file-select control 336 for identifying and uploading a file to be associated with the MOC ticket. Each file-select control 336 includes a text field 336a and a “Browse” radio button 336b. When the “Browse” button 336b is pressed, a file dialog opens, through which a user can select one or more files to include in the MOC ticket. Alternatively, instead of using the “Browse” button, the filename, including path, can be entered directly in the text field 336a. Not shown in FIG. 3, but accessible via scroll bar, or through a window larger than the one used in FIG. 3, is a Submit MOC Ticket radio button 338.

A user proposing a change may provide information regarding the proposed change through use of the Variation Form 310 and submit the MOC Ticket using the button 338. The structure provided by the Variation Form 310 facilitates tracking of change requests and collection of uniform data types (e.g., to track long-term trends, gather comparison statistics) across requests.

In addition to communicating a receipt to the requester, the technology communicates the submitted MOC ticket to an Analyst; preferably via e-mail alert, though also through use of Twitter, SMS, or a MOC client running on Analyst workstation. Referring to FIG. 10, in some embodiments an e-mail alert 1010 contains MOC data, e.g., MOC ID 214, Reason 332, Detail 334, Variation Type 324, Variation Target 326, Beginning Milepost 330a, Ending Milepost 330b from the Variation Form 310, including attachments, e.g., Notes.doc 1012 added using the file-select feature. In some embodiments, the e-mail alert contains a link to the ArcGIS project page. In some embodiments, the e-mail alert is an HTML-formatted message.

The analyst may implement the proposed change described in the MOC ticket/e-mail alert in an alternate route layer (ARL) of ArcGIS. The project Station Series, the layer in the GIS where the approved route change is stored, remains unchanged at this point. The ARL is a feature class, e.g., a spatial data object such as a point, polygon, polyline, topological element, stored in the ArcGIS database. Proposed route changes are stored in data objects of this feature class along with proposal date as metadata in the database for each project. Spatializing the proposed change in this fashion mitigates the likelihood of miscommunication among stakeholders.

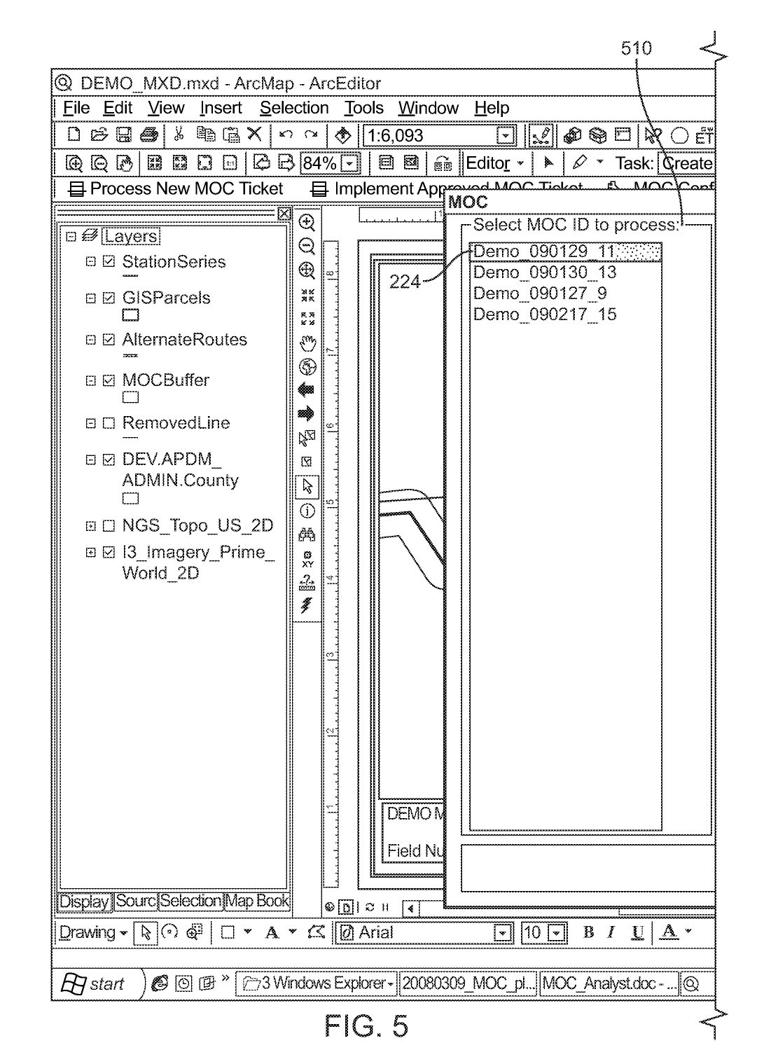

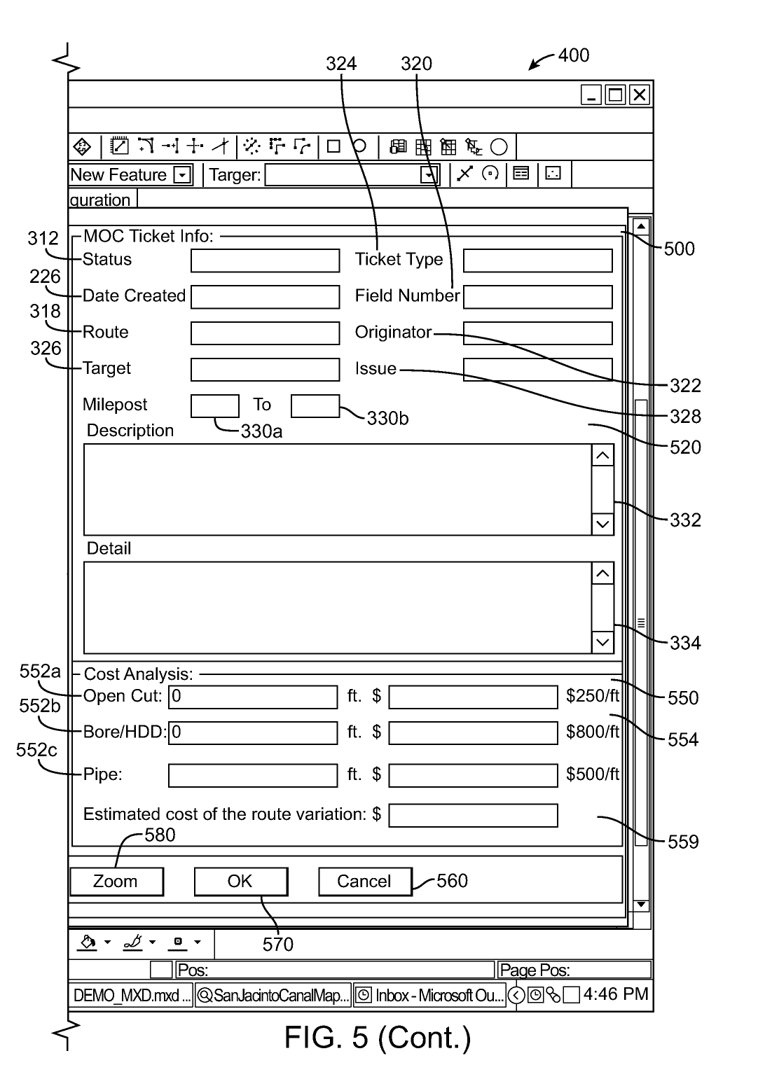

After making the appropriate changes, the analyst may activate the Process New MOC Ticket button 414a. FIG. 5 illustrates a response of the technology to activation of the Process New MOC Ticket button 414a. In FIG. 5, the technology displays a form window 500, in this case overlaid on an ArcGIS page, in response to activation of the Process New MOC Ticket button 414a. The form window contains a selectable list 510 of MOC tickets, a MOC Ticket Info pane 520, a Cost Analysis pane 550, and control buttons Zoom 580 (for zooming the image behind the window to the location of the ticket), OK 570, and Cancel 560. Some embodiments of the technology interact with scheduling software such as Primavera, e.g., to obtain “what if” estimate of the schedule impact of a proposed change.

An analyst can select a MOC ID, e.g., 224 from the list 510 of MOC IDs. The illustrated list includes MOC IDs from a single project, i.e., the Demo project. The technology populates those fields of the form 500 for which the MOC database has (or has access to) information. Much of the MOC Ticket Info pane 520 calls for information typically obtained through the Ticket Log 220 and the Variation Form 310, including Status 312, Date Created 226, Route 318, Target (Variation Target 326), Milepost (Beginning 330a, End 330b), Ticket Type (Variation Type 324), Field Number 320, Originator 322, Issue (Issue Type 328), Description (Reason for Route Variation 332), and Detail (Detail Route Variation 334). In some embodiments, Status 312, Details 334, and Description 332 fields can be updated at this point.

In some embodiments, the Cost Analysis pane 550 illustrated in FIG. 5 presents a simple cost model based on three types of pipeline sections, e.g., open cut 552a, bore 552b, and pipe 552c. The number of feet of each type of section can be edited. A scalar cost/foot, e.g., $250/ft. 554 is applied to each distance to result in a total summed cost 559.

If the Cancel button 560 is activated, the MOC ticket is not further processed. The Zoom button 580 allows a user to zoom the image behind the window to the location of the ticket. If the OK button 570 is activated, the data displayed/entered in the MOC Ticket Info pane 520 and the Cost Analysis pane 550 is saved as associated with the MOC ticket indicated in the selectable list 510, and the MOC ticket is ready for quality assurance review.

Upon activation of the OK button 570, a communication is prepared by the technology and sent to the MOC Administrator for quality assurance of the MOC ticket. Preferably the communication is an e-mail, e.g., FIG. 11, and includes an embedded link 1110 to MOC review pages, e.g., with attachments, e.g., with embedded form for reply. The MOC Administrator may review the processed MOC Ticket. The technology provides a selectable pass/fail indicator for the MOC administrator, and an opportunity to comment on the QC review of the ticket, e.g., a free text box.

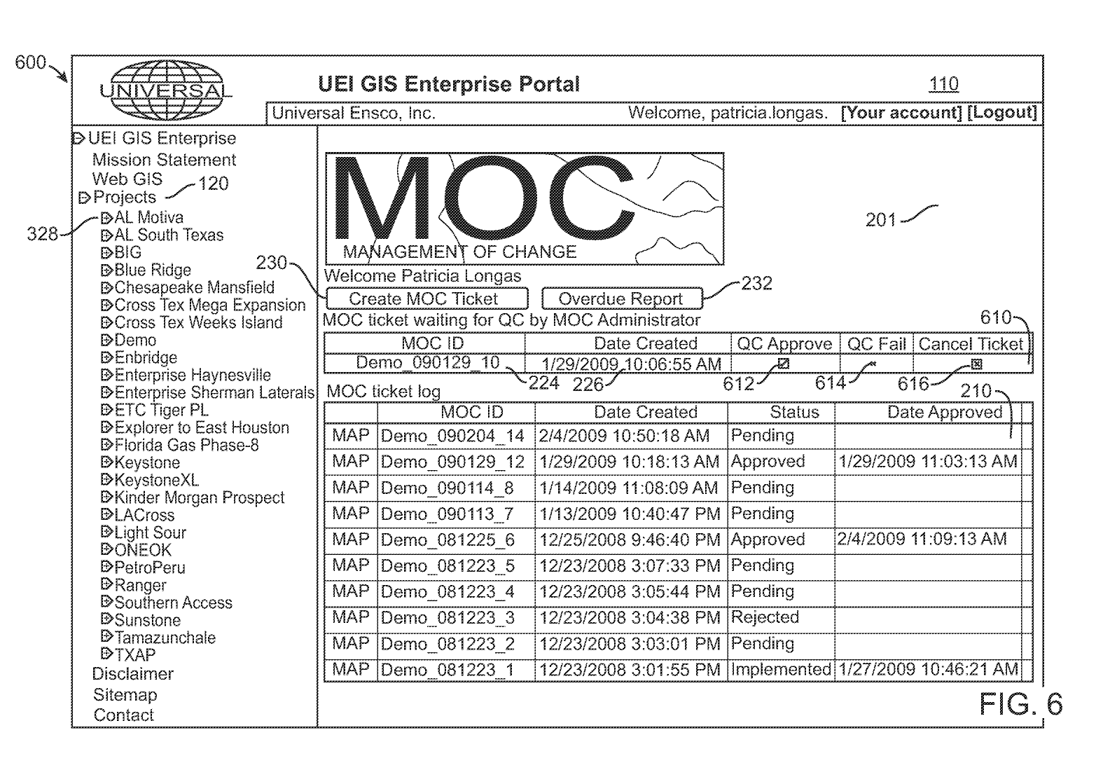

FIG. 6 illustrates a window 600 containing a GIS Enterprise Portal banner 110, navigation tree 120, and a MOC Ticket summary pane 201. In addition to the MOC ticket log 210, Create MOC Ticket radio button 230, and Overdue Report radio button 232 described elsewhere herein, the summary pane 200 illustrated in FIG. 6 includes a MOC tickets waiting for QC by MOC Administrator table 610. The table 610 identifies MOC tickets awaiting quality control by using the MOC ID 224 and Date Created 226 fields. Choices can be presented regarding QC status, e.g., QC Approved 612, QC Fail 614, and Cancel Ticket 616. The technology displays empty checkboxes (or equivalent status/choice graphics) to privileged users (the privilege in this case can be either view or view/write) and accepts choice input from appropriately-privileged users, e.g., an MOC Administrator responsible for quality control on the particular MOC ticket. The MOC Administrator may provide quality control to ensure that the proposed change has been properly captured and implemented as an ARL by the Analyst.

Upon receipt of a QC approval, e.g., through a MOC Admin user checking the QC approve checkbox 612, the technology communicates the MOC ticket along with the ARL and various MOC ticket attachments to various reviewers for review, comment, and approval/acknowledgment/rejection. The technology provides for various types of review, including comment/approve/reject review, comment-only review, comment/acknowledge review and combinations thereof.

Referring to FIG. 12, the communication is preferably in the form of an e-mail 1200. The communication can contain one or more links, e.g., 1210 including a link to the GIS enterprise portal page, a map, or a graphic file with a description and visualization of the original feature and changes that have been proposed.

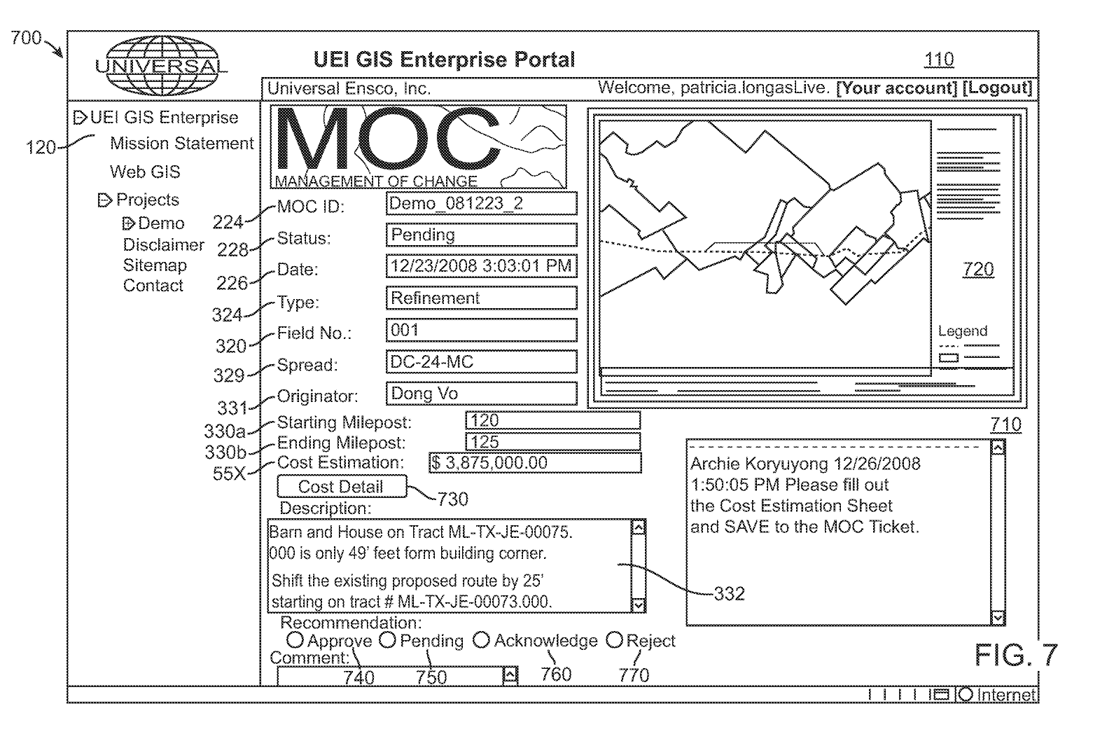

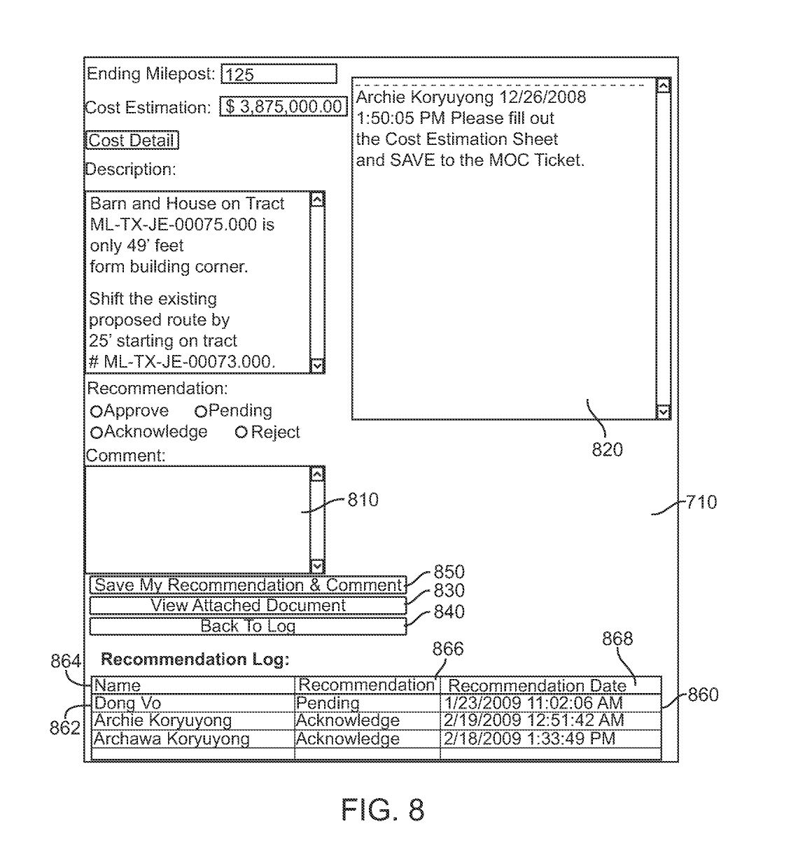

FIG. 7 and FIG. 8 (with FIG. 8 illustrating a continuation of FIG. 7 accessed using a scroll bar) illustrate a GIS portal page 700 serving as a target to a link provided to a stakeholder in a QC-approved MOC ticket e-mail message. The page includes a GIS Enterprise Portal banner 110, navigation tree 120, and a MOC ticket review pane 710. The technology populates the MOC ticket review pane 710 with information received by, or otherwise accessible to, the technology, e.g., MOC ID 224, Status 228, Date created 226, Type 324, Field No. 320, Spread 329, Originator 331, Starting Milepost 330a, Ending Milepost 330b, Cost Estimation 55X, Description 332 (a combination of Reason and Detail), and ARL 720. A Cost Detail radio button 730 provides a link to Cost Analysis data 550.

A reviewer may indicate a recommendation using any one of selection bullets Approve 740, Pending 750, Acknowledge 760, or Reject 770. “Pending” is an appropriate recommendation when a reviewer has added comments or a question, or is waiting for feedback from other reviewers before approving, acknowledging, or rejecting the proposed change. “Acknowledge” is to signal recognition that a change has been proposed, and intended primarily for reviewers not having opinions on the current issue.

The reviewer may add comments in a Comment text box 810. Comments that are saved, e.g., using the radio button Save My Recommendation & Comment 850, will appear in the comment journal 820 visible to other viewers. A reviewer may view comments added to the MOC ticket in the comment journal text box 820. A reviewer may view documents, e.g., image, word processing, spreadsheet, e-mail, attached to the MOC ticket using radio button 830. Activating the Back To Log radio button 840 takes the reviewer's browser to the MOC Ticket Summary page 200.

A Recommendation Log 860 is also available to the reviewer. The Recommendation Log 860 illustrated in FIG. 8 provides space for a plurality of recommendation log records 862. A recommendation log record can include a reviewer's Name 864, Recommendation 866, and Recommendation Date 868. The technology can control the order among reviewers, e.g., the technology can require input from an environmental reviewer before any engineering reviewers can submit comments or a recommendation. A reviewer may save a recommendation (e.g., including the data entered by that reviewer in the review pane 710 using radio button 850.

The technology can employ various procedures for closure of review. In some embodiments, rejection of the proposed change by any one reviewer with approve/reject privilege renders the proposed change rejected. In other embodiments, all recommendations received within a predetermined time are tallied and the proposed change is approved if some portion (e.g., a majority, a predetermined supermajority) of reviewers approve. In some embodiments, a weight can be applied to the recommendation of each user. A predetermined time for review can be applied. Closure can be dependent on the necessary acknowledgement, approval, or rejection of certain reviewers. An order of review and recommendation can be imposed.

Upon rejection of a MOC ticket, the technology will archive the MOC ticket and notify stakeholders.

Upon approval of a MOC ticket, the technology will commit the changes (both text data changes and ARL) to the project database upon activation of the Implement Approved MOC Ticket button 414b in the MOC toolbar 414 installed in ArcGIS. In some embodiments, the technology will then communicate to stakeholders that an approved change has been implemented, e.g., with an e-mail as illustrated in FIG. 13.

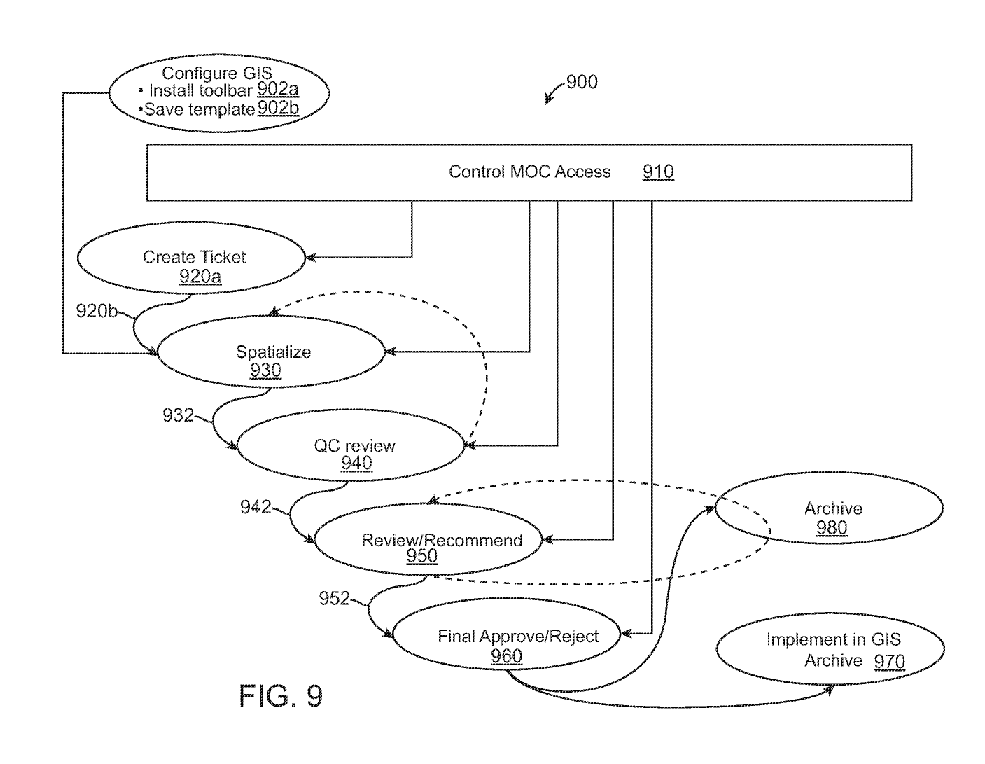

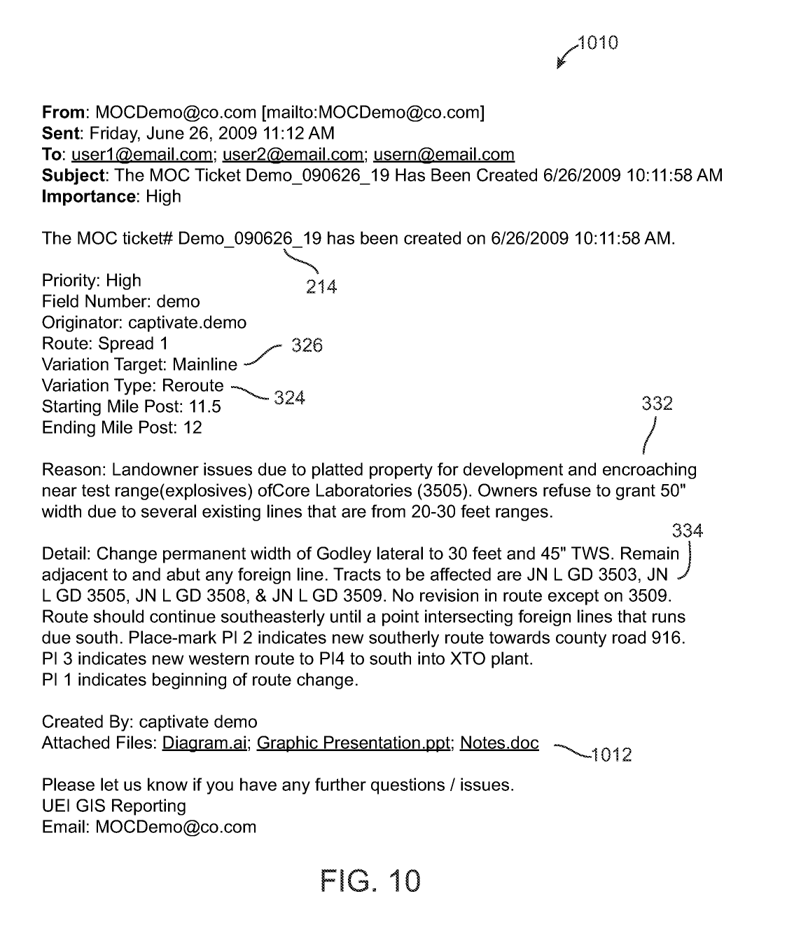

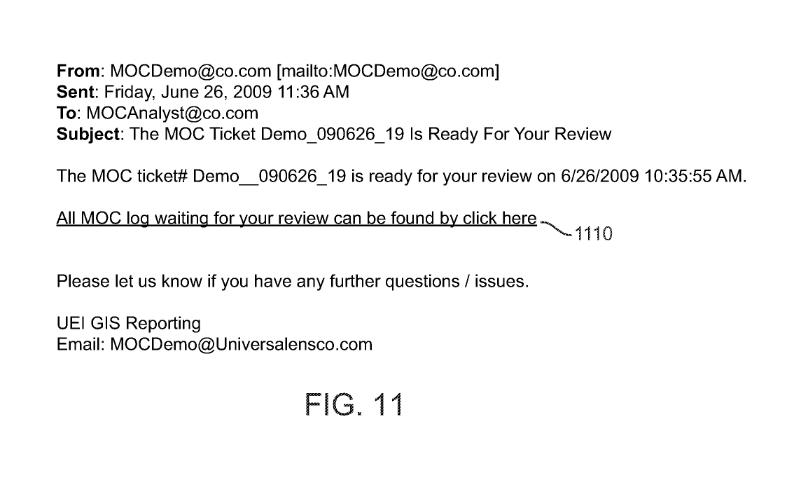

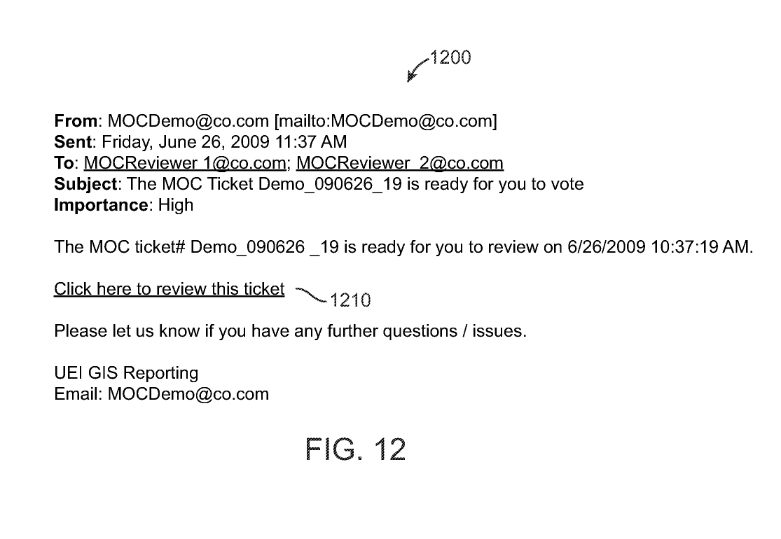

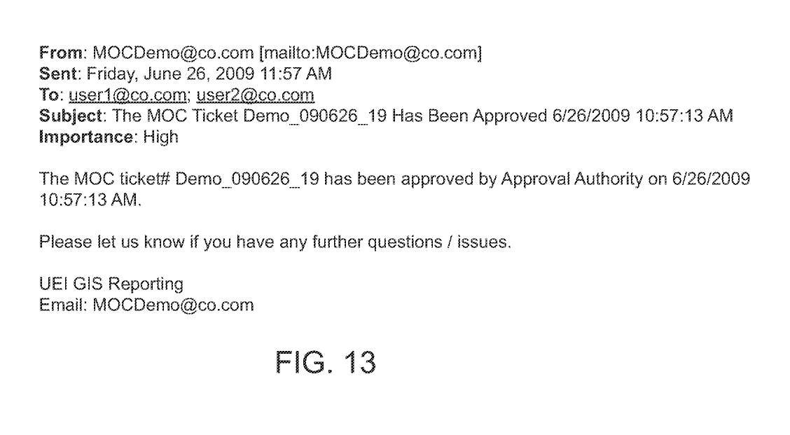

FIG. 9 illustrates a process 900 using the technology described above. A toolbar of the technology is installed 902a in a corresponding GIS, and drawing template of the technology is saved 902b as a drawing template of the GIS. The technology controls access 910 to functionality offered by the technology, e.g., through login requiring username and password, and a profile controlling the capabilities available to logged in users.

After a user conceives a proposed change to the design of a route-based project and logs in, the system assists the user to create a MOC ticket 920a, e.g., through displaying the Variation Form 310, populating fields of that form from the GIS and MOC databases, and receiving data such as Reason 332, Detail 334, and attachments. A created MOC ticket is communicated to a MOC analyst 920b.

After the Analyst logs in 910, the Analyst accesses the MOC ticket and spatializes (e.g., creates an ARL from the drawing template and the information contained in the MOC ticket) 930 the request. The spatialized request is communicated 932 to a quality control reviewer. The reviewer, typically a MOC Administrator reviews 940 the spatialized request, and can accept, reject, and provide feedback 940a, via a text box, to the Analyst. The Analyst may then access the MOC ticket and make appropriate changes as described above, upon which the system again communicates 932 the MOC ticket to the reviewer. This portion of the method is iterative.

Upon QC approval of the spatialized MOC ticket, the QC-approved MOC ticket is communicated to one or more reviewers for review and recommendations 950. After logging in 910, review and recommendation can be an iterative process, e.g., reviewers can view MOC ticket information, including attachments and create comments while leaving the recommendation “Pending” 750.

The Review/Recommend process 950 can be conduct in parallel or at least in part in series. In a series part, the process 950 proceeds in a predetermined order of reviewers, e.g., requiring approval or specified input from one or more reviewer(s) before communicating the QC-approved MOC ticket to another reviewer(s), or before allowing other reviewer(s) to comment or recommend. The order and extent of review can be controlled by other criteria including outcome, role, etc.

The Review/Recommend process 950 is terminated according to predetermined criteria. Such criteria include: upon receipt of recommendations from all reviewers, upon rejection from one or more predetermined reviewers.

In some embodiments, such as the embodiment illustrated in FIG. 9, final approval is not a deterministic function of the recommendations of the reviewers, but resides in one or more final approval authorities. In those cases, the final recommendation is communicated 952 to the final approval authorities, e.g., in a manner of communication as described herein for other steps, for final approval or rejection 960. In some embodiments, the technology can provide final approval authorities the option to return the MOC ticket to an Analyst with comments that can call for re-spatialization 930, after which QC review 940 and Review/Recommend 950 steps can be iteratively performed.

Finally rejected MOC tickets can be archived 980, while finally approved MOC tickets are implemented in the GIS 970. Both approvals and rejections can be communicated to stakeholders and reviewers.

In cooperation with the GIS, the technology can provide access to functionality and can gather the data needed by the functionality, e.g., the technology can use MOC ticket information to perform a spatial query on the GIS to determine parcels impacted by the proposed change. Notification of impacted parcels can be used by registered public land surveyors for e.g., cost analysis, determining easements to obtain, and legal recordation of changed plans.

Aspects described above can be implemented as computer executable code modules that can be stored on computer readable media, read by one or more processors, and executed thereon. In addition, separate boxes or illustrated separation of functional elements of illustrated systems does not necessarily require physical separation of such functions, as communications between such elements can occur by way of messaging, function calls, shared memory space, and so on, without any such physical separation. More generally, a person of ordinary skill would be able to adapt these disclosures to implementations of any of a variety of communication devices. Similarly, a person of ordinary skill would be able to use these disclosures to produce implementations and embodiments on different physical platforms or form factors without deviating from the scope of the claims and their equivalents.

The present technology can take the form of hardware, software or both hardware and software elements. In some embodiments, the technology is implemented in software, which includes but is not limited to firmware, resident software, microcode, an FPGA or ASIC, etc. In particular, for real-time or near real-time use as in a patient position monitor, an FPGA or ASIC implementation is desirable.

Furthermore, the technology can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Processors, media, and program code for implementing each as aspect of the technology can be centralized or distributed (or a combination thereof) as known to those skilled in the art.

Data processing systems suitable for storing a computer program product of the present technology and for executing the program code of the computer program product will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters can also be coupled to the system to enable the data processing system to become coupled to other data processing systems or remote printers or storage devices through intervening private or public networks. Modems, cable modem and Ethernet cards are just a few of the currently available types of network adapters. Such data processing systems can be multiprocessor and distributed across platforms separate geographically; with the computer programs resident and executable thereon being either centralized or distributed across platforms.

Specifically, the technology can include a GIS database (e.g, MS SQL Server using Arc GIS as an interface) implemented on a server. External applications for document management that can be used in systems of the technology include, file managers (e.g., FileNet, LaserFile, OpenDocs). The technology can be integrated with schedule management technology such as Primavera at the schedule status level (though not the baseline level in some embodiments). Programs such as Adobe Acrobat can be used to generate pdf files and tiff files. Systems of the technology interoperate with ESRI ArcGIS suite: ArcGIS Desktop, ArcObjects API, SDE, and ArcGIS Server.

1. A computer-implemented method for managing change in a design of a route-based project, the method comprising:
in a data processing system,
receiving first data regarding a proposed change to the design of a route-based project, the first received data comprising a ticket;
associating the ticket with design of the project in a geographic information system (GIS);
communicating the proposed change to an Analyst;
receiving spatializing data regarding the proposed change, the ticket and spatializing data comprising a spatialized ticket;
communicating the spatialized ticket to a Quality Control Administrator;
receiving quality control approval of the spatialized ticket;
communicating the quality control approved ticket to at least one reviewer;
receiving a recommendation from at least one of the at least one reviewers, the recommendations and the quality control approved ticket comprising a reviewed ticket;
communicating the reviewed ticket to at least one approver;
receiving approval from at least one of the at least on approver, the approval and the reviewed ticket comprising an approved ticket; and
committing the change described in the reviewed ticket to the GIS.

2. A computer program product for managing change in a design of a route-based project, the method comprising:
computer readable media, and
program code, residing on the medium and containing instructions that when executed by a processor:
receive first data regarding a proposed change to the design of a route-based project, the first received data comprising a ticket;
associate the ticket with design of the project in a geographic information system (GIS);
communicate the proposed change to an Analyst;
receive spatializing data regarding the proposed change, the ticket and spatializing data comprising a spatialized ticket;
communicate the spatialized ticket to a Quality Control Administrator;
receive quality control approval of the spatialized ticket;
communicate the quality control approved ticket to at least one reviewer;
receive a recommendation from at least one of the at least one reviewers, the recommendations and the quality control approved ticket comprising a reviewed ticket;
communicate the reviewed ticket to at least one approver;
receive approval from at least one of the at least on approver, the approval and the reviewed ticket comprising an approved ticket; and
commit the change described in the reviewed ticket to the GIS.

3. A system for managing change in a design of a route-based project, the method comprising:
at least one processor,
computer readable media, and
program code, residing on the medium and containing instructions that when executed by the at least one processor:
receive first data regarding a proposed change to the design of a route-based project, the first received data comprising a ticket;
associate the ticket with design of the project in a geographic information system (GIS);
communicate the proposed change to an Analyst;
receive spatializing data regarding the proposed change, the ticket and spatializing data comprising a spatialized ticket;
communicate the spatialized ticket to a Quality Control Administrator;
receive quality control approval of the spatialized ticket;
communicate the quality control approved ticket to at least one reviewer;
receive a recommendation from at least one of the at least one reviewers, the recommendations and the quality control approved ticket comprising a reviewed ticket;
communicate the reviewed ticket to at least one approver;
receive approval from at least one of the at least on approver, the approval and the reviewed ticket comprising an approved ticket; and
commit the change described in the reviewed ticket to the GIS.
